(19) United States
(12) Patent Application Publication
(10) Pub. No.: US 2017/0316180 A1
(43) Pub. Date: Nov. 2, 2017

(54) BEHAVIOR PREDICTION APPARATUS, BEHAVIOR PREDICTION APPARATUS CONTROLLING METHOD, AND BEHAVIOR PREDICTION APPARATUS CONTROLLING PROGRAM

(71) Applicant: UBIC, INC., Tokyo (JP)

(72) Inventors: Hideki TAKEDA, Tokyo (JP); Akiteru HANATANI, Tokyo (JP)

(73) Assignee: UBIC, INC., Tokyo (JP)

(21) Appl. No.: 14/902,323

(22) PCT Filed: Jan. 26, 2015
(86) PCT No.: PCT/JP2015/051963

§ 371 Date: Dec. 30, 2015

(51) Int. Cl. G06F 19/00; G06N 5/04

(52) U.S. Cl. CPC G06F 19/3487; G06N 5/04; G06F 19/322; G06F 19/345

(57) ABSTRACT

A memory unit stores medical information related to a patient's dangerous behavior and extracted in advance from judged medical record information which is medical record information identifying the dangerous behavior by being linked to an incident report about the patient's dangerous behavior. A relation evaluation unit acquires unjudged medical record information, to which the incident report is not linked, and evaluates a relation between the unjudged medical record information and a possible dangerous behavior of the patient corresponding to the unjudged medical record information on the basis of the medical information related to the dangerous behavior stored in the memory unit. A prediction unit predicts the patient's dangerous behavior corresponding to the unjudged medical record information according to an evaluation result of the relation evaluation unit. A data reporting unit reports a prediction result of the prediction unit.

### CROSS-REFERENCE TO RELATED APPLICATIONS

The present application is a national phase application of PCT application PCT/JP2015/051963 filed Jan. 26, 2015, the disclosure of which is incorporated herein by reference.

### BACKGROUND

### Technical Field

The present invention relates to a behavior prediction apparatus, a behavior prediction apparatus controlling method, and a behavior prediction apparatus controlling program.

### Background Art

Since people have been taking more interest in medical accidents in recent years, it can be said that those who are engaged in medical services are facing growing risks of medical lawsuits.

On the other hand, recording of medical accidents and management of near-miss incidents are generally conducted during medical practices such as at hospitals by keeping incident reports, occurrence reports, and so on. There is a known technique that predicts the occurrence of future medical accidents by analyzing these incident reports and occurrence reports and thereby extracting information about accident factors which have occurred during the medical practices.

### CITATION LIST

### Patent Literature

PTL 1: Japanese Patent Application Laid-Open (Kokai) Publication No. 2008-165680

PTL 2: Japanese Patent No. 3861986

### SUMMARY OF THE CLAIMED INVENTION

### Problems to be Solved by the Invention

The incident reports or the occurrence reports may be prepared with respect to not only accidents caused by medical practices, but also accidents caused by a patient's behavior(s) such as the patient's tumbling or falling. The inventor of the present application has come to realize the possibility to predict the occurrence of an accident caused by the patient's behavior(s), that is, the occurrence of the patient's dangerous behavior by referring to the incident reports or the occurrence reports.

The present invention was devised in light of the above-described problem and it is an object of the invention to provide a technique that predicts the occurrence of the patient's dangerous behavior.

### Means for Solving the Problems

In order to solve the above-described problem, a behavior prediction apparatus according to an embodiment of the present invention includes: a memory unit that stores medical information related to a patient's dangerous behavior and extracted in advance from judged medical record information which is medical record information identifying the dangerous behavior by being linked to an incident report about the patient's dangerous behavior; a relation evaluation unit that acquires unjudged medical record information, to which the incident report is not linked, and evaluates a relation between the unjudged medical record information and a possible dangerous behavior of the patient corresponding to the unjudged medical record information on the basis of the medical information related to the dangerous behavior stored in the memory unit; a prediction unit that predicts the patient's dangerous behavior corresponding to the unjudged medical record information according to an evaluation result of the relation evaluation unit; and a data reporting unit that reports a prediction result of the prediction unit.

The behavior prediction apparatus according to an embodiment of the present invention may further include, for example, a score calculation unit that calculates a score indicative of strength of a relation between the medical information related to the dangerous behavior and the dangerous behavior. The relation evaluation unit may evaluate whether the unjudged medical record information and the dangerous behavior are related to each other or not, by using the score calculated by the score calculation unit as an index indicative of a relation between the medical information included in the unjudged medical record information and the dangerous behavior; and when the relation evaluation unit evaluates that the unjudged medical record information and the dangerous behavior are related to each other, the data reporting unit may report it to a healthcare professional.

The behavior prediction apparatus may further include an element evaluation unit that evaluates each data element of the medical information included in the judged medical record information on the basis of a specified standard. The score calculation unit may calculate the score by using a result evaluated by the element evaluation unit.

The behavior prediction apparatus may further include a threshold value identification unit that identifies, as a specified threshold value, a score in excess of a target value which is set for a precision, from among scores calculated by the score calculation unit, as an index indicative of the relation between the medical information included in the judged medical record information and the dangerous behavior by using the result evaluated by the element evaluation unit.

The behavior prediction apparatus may further include a condition judgment unit that judges whether a correlation between a moving average of scores calculated respectively for a plurality of pieces of judged medical record information acquired in chronological order and a moving average of scores calculated respectively for a plurality of pieces of unjudged medical record information acquired in chronological order is high or low. The relation evaluation unit may evaluate the relation between the medical information included in the unjudged medical record information and the dangerous behavior on the basis of a result judged by the condition judgment unit.

The behavior prediction apparatus may further include a judged data acquisition unit that acquires the judged medical record information by acquiring an incident report about a specified dangerous behavior and a result of judgment by a user as to whether specified medical information included in medical record information linked to the incident report is related to the specified dangerous behavior or not, from the user via a specified input unit.

The behavior prediction apparatus may further include a relation assignment unit that assigns relation information indicating that the medical information included in the unjudged medical record information is related to the specified dangerous behavior on the basis of the result evaluated by the relation evaluation unit.

The dangerous behavior may be at least either the patient's tumbling or falling of the medical record information.

Another embodiment of the present invention is a behavior prediction apparatus controlling method for predicting the patient's dangerous behavior. This method includes: an extraction step of extracting medical information related to a patient's dangerous behavior from judged medical record information which is medical record information identifying the dangerous behavior by being linked to an incident report about the patient's dangerous behavior; a relation evaluation step of acquiring unjudged medical record information, to which the incident report is not linked, and evaluating a relation between the unjudged medical record information and a possible dangerous behavior of the patient corresponding to the unjudged medical record information on the basis of the medical information related to the extracted dangerous behavior; a prediction step of predicting the patient's dangerous behavior corresponding to the unjudged medical record information according to an evaluation result in the relation evaluation step; and a data reporting step of reporting a prediction result.

### Advantageous Effects of Invention

The technique that predicts the occurrence of the patient's dangerous behavior(s) can be provided according to the present invention.

### BRIEF DESCRIPTION OF THE DRAWINGS

FIG. 1 is a diagram schematically illustrating an example of the appearance of an incident report;

FIG. 2 is a diagram schematically illustrating an example of an electronic medical record screen;

FIG. 3 is a block diagram illustrating a major part configuration of a behavior prediction apparatus according to an embodiment of the present invention; and

FIG. 4 is a flowchart for explaining a flow of danger prediction processing executed by the behavior prediction apparatus according to an embodiment of the present invention.

### DETAILED DESCRIPTION

### Outline of Behavior Prediction Apparatus

The outline of a behavior prediction apparatus according to an embodiment will be explained. The behavior prediction apparatus according to the embodiment is an apparatus for predicting a dangerous behavior that a patient may conduct with high probability on the basis of an electronic medical record in which medical and nursing care services performed for the patient and follow-up information are described. The behavior prediction apparatus only has to be equipment (information processing apparatus) capable of executing processing explained below and may be implemented by using, for example, a personal computer, a smartphone, or other electronic devices. Furthermore, the behavior prediction apparatus may be implemented as a computer system in which a plurality of information processing apparatuses divide and execute the processing explained below.

The behavior prediction apparatus acquires, for example, a patient's medical record information as unjudged medical record information by which a dangerous behavior that the patient may possibly conduct is not predicted. The “dangerous behavior” herein used includes the patient's behavior or accident, regarding which an incident report should be made, such as the patient's tumbling, bruise, broken bones, falling, or incontinence. Incidentally, the details of the incident report and the medical record information will be described later.

When a certain patient's unjudged medical record information is newly acquired, the behavior prediction apparatus predicts the patient's dangerous behavior of unjudged medical record information on the basis of medical record information linked to incident reports which have already been made (hereinafter sometimes referred to as the “judged medical record information”). Specifically speaking, the behavior prediction apparatus extracts data elements (such as keywords, sentences, paragraphs, partial images, partial voices, or partial video pictures constituting texts, voices, images, and/or video pictures included in the relevant unjudged medical record information) from the unjudged medical record information and calculates a score of the relevant unjudged medical record information from each of the relevant data elements evaluated by using the judged medical record information. Then, when the calculated score satisfies a specified condition (for example, when the relevant score exceeds a specified threshold value), the behavior prediction apparatus reports it as a dangerous behavior predicted about the patient of the unjudged medical record information to a healthcare professional who is a prediction report demander (such as the patient, a doctor(s), or a nurse(s)).

Specifically speaking, the behavior prediction apparatus can: predict the patient's dangerous behavior corresponding to the unjudged medical record information on the basis of a judgment result by a doctor or a nurse as to whether the relation with a specified dangerous behavior exists or not; and report the predicted result to the prediction report demander. For example, when an experienced doctor experiences a near-miss incident (an experience of an incident that was not so serious as to be considered as the patient's dangerous behavior, but might have led to the dangerous behavior), the behavior prediction apparatus leans the relation between the situation of the relevant near-miss incident and medical record information indicative of that situation; and when similar medical record information is acquired as a result of a similar situation encountered by a poorly-experienced healthcare professional, the behavior prediction apparatus can inform the healthcare professional that the dangerous behavior may possibly occur.

Therefore, the behavior prediction apparatus according to the embodiment can inform the healthcare professional that the occurrence of the patient's dangerous behavior is predicted.

### Incident Report and Medical Record Information

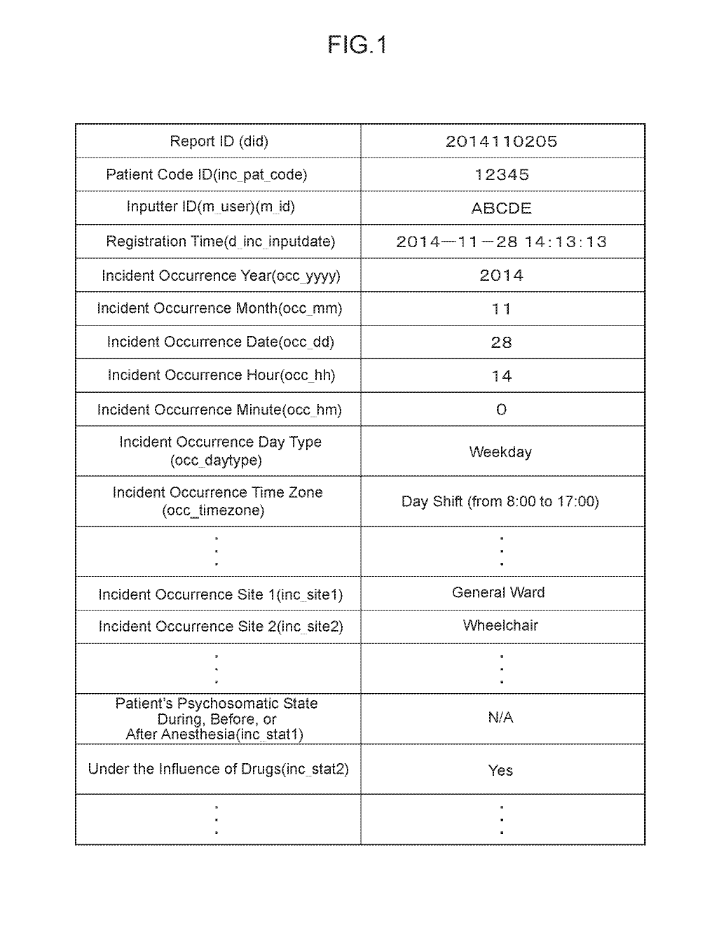

FIG. 1 is a diagram schematically illustrating an example of the appearance of an incident report. The incident report is generally a report prepared by a healthcare professional such as a nurse when the healthcare professional has experienced a situation in the medical practice that was not so serious to cause any damage to a patient, but could have caused such damage. On the other hand, an occurrence report is a report prepared by the healthcare professional such as a nurse when some damage was actually caused to a patient during the medical practices. The occurrence report is sometimes called an accident report. It should be noted that whatever damage which may be caused to the patient includes not only a medical accident caused by a mistake in drug administration or surgery, but also injury caused by, for example, the patient's tumbling or falling from a wheelchair.

Although the incident report is different from an accident report with respect to what causes the healthcare professional to prepare the report (whether actual damage has been caused to the patient or not) as described above, they share a common feature that they are both reports prepared when any disadvantage situation for the patient has occurred. So, in this description, the “incident report” shall include the “occurrence report” or “accident report.” Moreover, whatever situation that has caused the healthcare professional to prepare the incident report may sometimes be described as an “incident.”

The behavior prediction apparatus 100 according to the embodiment focuses attention on an incident report prepared as triggered particularly by a patient's own dangerous behavior as described above. However, those skilled in the art would understand that the prevent invention will come into effect even when adopting an incident report prepared as triggered by not only the patient's own dangerous behavior, but also a so-called medical accident.

In an incident report illustrated in FIG. 1, a plurality of pieces of information related to an incident are listed in a table format. Although not all items will be explained to avoid complication, the incident report describes, for example, a patient code ID for uniquely identifying the relevant patient, a year, month, day, and time zone of the occurrence of the relevant incident, an incident occurrence site, and the state of the patient.

Since the incident report is made when any disadvantageous situation for the patient has occurred as described above, normally whatever treatment or prescription of drugs is given to that patient. In an electronic medical record, medical information such as the treatment given to the patient and the drugs prescribed for the patient is described as medical record information.

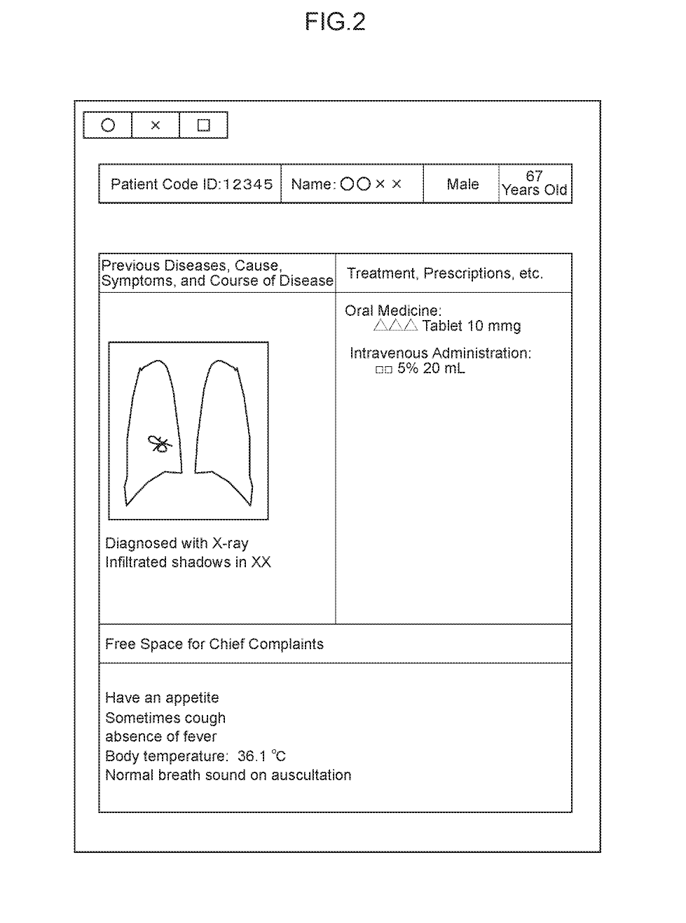

FIG. 2 is a diagram schematically illustrating an example of a screen of the electronic medical record. Generally, the “medical record” is to record medical information such as medical treatment records and examination results. The electronic medical record is a system designed so that this medical information can be electronically saved, viewed, and used. Since the electronic medical record is an electronic form of the medical information, it is easier to, for example, make a database or network of the medical information or reuse the medical information than the medical record in a written form.

Regarding the electronic medical record illustrated in FIG. 2, the aforementioned medical information is displayed on an itemized basis. For example, at the top of screen of the electronic medical record, a patient code ID, the patient's name, sex, and age for identifying the relevant patient are displayed. The patient code ID in the electronic medical record illustrated in FIG. 2 is the same as the patient code ID in the incident report illustrated in FIG. 1. This indicates that the patient in the electronic medical record illustrated in FIG. 2 is identical to the patient in the incident report illustrated in FIG. 1. Accordingly, one incident report is linked to (or is associated with) one electronic medical record via, for example, the patient code ID.

The electronic medical record includes descriptions of the medical information such as the patient's previous diseases, image data obtained by taking images with various medical devices, treatments given to the patient, drugs prescribed for the patient, and a free space for the patient's chief complaints as illustrated in FIG. 2. Although it is not indicated in the diagram, voice records of conversations between healthcare professionals such as doctors and the patient may be linked to the electronic medical record.

### Configuration of Behavior Prediction Apparatus 100

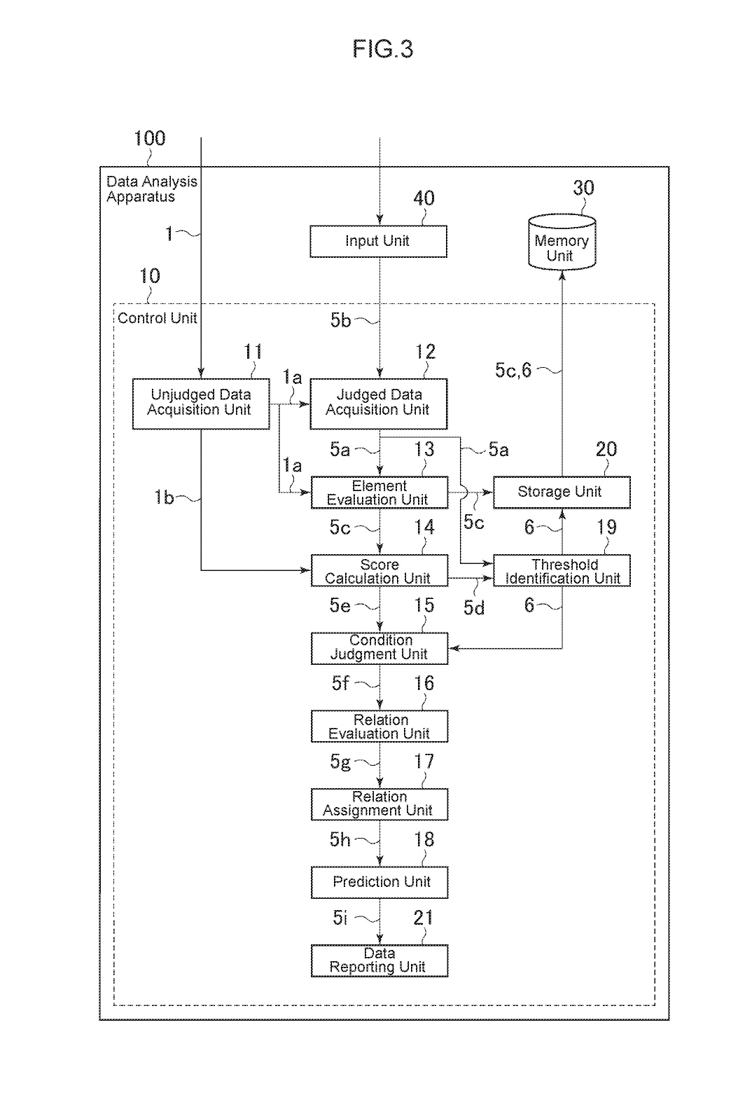

FIG. 3 is a block diagram indicative of a major part configuration of the behavior prediction apparatus 100. Referring to FIG. 3, the behavior prediction apparatus 100 includes a control unit 10 (an unjudged data acquisition unit 11, a judged data acquisition unit 12, an element evaluation unit 13, a score calculation unit 14, a condition judgment unit 15, a relation evaluation unit 16, a relation assignment unit 17, a prediction unit 18, a threshold value identification unit 19, a storage unit 20, and a data reporting unit 21), an input unit 40, and a memory unit 30.

The control unit 10 controls various kinds of functions of the behavior prediction apparatus 100 in an integrated manner. The control unit 10 includes the unjudged data acquisition unit 11, the judged data acquisition unit 12, the element evaluation unit 13, the score calculation unit 14, the condition judgment unit 15, the relation evaluation unit 16, the relation assignment unit 17, the prediction unit 18, the threshold value identification unit 19, the storage unit 20, and the data reporting unit 21.

The unjudged data acquisition unit 11 acquires medical information 1 from the patient's medical record information. The “medical information” herein used may be any data as long as it is data about the patient, for example, not only medical treatments given by doctors or nurses to the patient, but also the patient's age, sex, previous medical history, hospitalization history, height, body weight, blood pressure, blood conditions, hospitalization time, gene analysis data, life data, medical interview data (for example, nausea or dizziness, the symptom has lasted for about one week or so, the pain feels better when lying down facing their left side, or the patient feels burning pain in their affected area), life data (for example, smoking, drinking alcohols every day, and sport habits), the patient's clinical data (for example, pregnant or diabetic), family's medical history (for example, the patient's father suffered cerebral infarction or mother suffered a cancer), and image data taken by various kinds of modality.

The unjudged data acquisition unit 11 outputs data 1a regarding which a doctor should judge whether it is related to a specified dangerous behavior that the patient may conduct or not, from among the acquired medical information 1, to the judged data acquisition unit 12 and the element evaluation unit 13 and outputs other data 1b (unjudged medical information) to the score calculation unit 14. It should be noted that the medical information included in the medical record information which is not limited to any incident report is the unjudged medical information. Therefore, in this description below, the “unjudged medical record information” means the unjudged medical information described there.

The judged data acquisition unit 12 acquires a result of judgment by the doctor regarding whether the data 1a is related to the specified dangerous behavior or not (a review result 5a), from the relevant doctor via the input unit 40. Accordingly, the judged data acquisition unit 12 acquires the judged medical information (a pair of the data 1a and the review result 5a). Specifically speaking, the judged data acquisition unit 12 acquires the review result 5a corresponding to the data 1a input from the unjudged data acquisition unit 11 on the basis of input information 5b acquired from the input unit 40. Then, the judged data acquisition unit 12 outputs the relevant review result 5a to the element evaluation unit 13 and the threshold value identification unit 19.

It should be noted that the doctor who gives the review result 5a to the behavior prediction apparatus 100 and the doctor who receives the review result from the relevant behavior prediction apparatus 100 (that is, the doctor who is informed of the data 1b from the relevant behavior prediction apparatus 100) may be the same doctor or different doctors. In the latter case, for example, the behavior prediction apparatus 100 can learn experiences and judgment standards of an experienced doctor and report the data 1b to a poorly-experienced doctor on the basis of the relevant learning result. In other words, the behavior prediction apparatus 100 can make use of the experienced doctor's experiences, knowledge, and findings for the benefit of the poorly-experienced doctor.

The element evaluation unit 13 evaluates each of the data elements, which are the medical information included in the judged medical record information, in accordance with specified standards. Specifically speaking, if the data 1a is written character information in various kinds of examination results or medical records, the element evaluation unit 13 converts the relevant character information into document data. If the data 1a is voice information at medical interviews, the element evaluation unit 13 converts the voice information at the relevant medical interviews into characters (document data) by recognizing the voice information at the relevant medical interviews. Then, the element evaluation unit 13 uses a transmitted information amount indicative of a dependency relation between keywords (data elements) included in the relevant document data and the judgment result by the doctor with respect to the data 1a including the relevant keywords (for example, the voice information at the medical interviews, or various kinds of examination results, the character information of the medical records, etc., and combinations of these pieces of data) (the review result 5a), as one of the specified standards to calculate the weight of the relevant keywords, thereby evaluating the relevant keywords. It should be noted that the element evaluation unit 13 may recognize the voice information at the medical interviews by using an arbitrary voice recognition algorithm (such as the hidden Markov model, Kalman filter, or neural network).

Furthermore, if the data 1a is image information, the element evaluation unit 13 can identify an object included in the image information as a data element by using an arbitrary image recognition technique (for example, techniques such as machine learning using boosting or support vector machines, pattern matching, Bayesian estimation, or Markov chain Monte Carlo methods). Then, the element evaluation unit 13 calculates the weight of the object (data element) included in the relevant image information by using the transmitted information amount indicative of the dependency relation between the object and the result of judgment by the doctor on the data 1a (image information) including the object (the review result 5a) as one of the aforementioned specified standards, so that it can evaluate the object. The element evaluation unit 13 outputs element information 5c about a pair constituted from the above-mentioned data element and the weight of that data element to the score calculation unit 14 and the storage unit 20.

The score calculation unit 14 calculates a score 5d indicative of the strength of the relation between the data 1a and a specified dangerous behavior by using the result evaluated by the element evaluation unit 13 (the element information 5c). The score calculation unit 14 outputs the calculated score 5d to the threshold value identification unit 19. Furthermore, when the data 1b (the unjudged medical information) is input from the unjudged data acquisition unit 11, the score calculation unit 14 calculates a score 5e about the relevant data 1b and outputs the calculated score 5e to the condition judgment unit 15.

The score calculation unit 14 can calculate the score (the score 5d or the score 5e) of the relevant medical information 1 by totalizing weights of data elements included in the medical information 1 (the data 1a or the data 1b). For example, let us assume that the medical information 1 is a record which is included in the medical record and describes that a specific drug was administered one day before. In this case, when weights “1.2” and “2.2” are set as a result of evaluation of data elements indicating “one day before” and “drug name” respectively by the element evaluation unit 13, the score calculation unit 14 can calculate the score of the relevant data 1 as “3.4” (1.2+2.2).

Specifically speaking, the score calculation unit 14 generates an element vector indicating whether a specified data element is included in the medical information 1 or not. The above-mentioned element vector is a vector indicating whether the specified data element associated with the relevant element of the element vector is included in the above-mentioned medical information 1 or not, by -mentioned medical information 1 includes the data element “one day before,” the score calculation unit 14 changes an element corresponding to “about one week before” in the above-mentioned element vector from “0” to “1.” Then, the score calculation unit 14 calculates score S of the above-mentioned data 1 by calculating an inner product between the above-mentioned element vector (column vector) and a weight vector (column vector whose element(s) the weight of each data element) as indicated in the following expression.

S=w^{T}·s Math.1

In the above expression, s represents the element vector and W represents the weight vector. Incidentally, T represents transposition of the matrix/vectors (switching between a row and a column).

Alternatively, the score calculation unit 14 may calculate score S according to the following expression.

$$S = \frac{{\sum }_{j = 0}^{N} {jm}_{j} {w}_{j}^{2}}{{\sum }_{i = 0}^{N} {iw}_{i}^{2}} \qquad Math . 2$$

In the above expression, mⱼ represents appearance frequency of a j-th data element and wᵢ represents the weight of an i-th data element.

It should be noted that the score calculation unit 14 may calculate the score 5d and/or the score 5e on the basis of the evaluation result of a first data element included in the data 1a and/or the data 1b (the weight of the first data element) and the evaluation result of a second data element included in the data 1a and/or the data 1b (the weight of the second data element). Specifically speaking, when the first data element appears in the data, the score calculation unit 14 can calculate the score of the data in consideration of frequency at which the second data element appears in the relevant data (that is, also referred to as correlation or co-occurrence between the first data element and the second data element). As a result, the behavior prediction apparatus 100 can calculate the score in consideration of the correlation between the data elements, so that it can extract the data of the medical information 1 related to a specified dangerous behavior with higher precision.

The condition judgment unit 15 judges whether the data 1b satisfies specified conditions to report the relevant data 1b to the prediction report demander or not, on the basis of the score 5e calculated by the score calculation unit 14. For example, the condition judgment unit 15 may judge whether the relevant score 5e exceeds a threshold value of precision(a specified threshold value) 6 or not, as one of the above-mentioned specified conditions by comparing the score 5e with the threshold value of precision 6.

Alternatively, the condition judgment unit 15 may judge whether the correlation between a moving average of scores 5d respectively calculated for a plurality of pieces of data 1a acquired in chronological order and a moving average of scores 5e respectively calculated for a plurality of pieces of data 1b acquired in chronological order has become higher or not, as one of the above-mentioned specified conditions. For example, if the review result 5a indicating that the above-mentioned plurality of pieces of the data 1a are of the situation where a near-miss incident has been experienced (the situation where the patient's behavior was not so serious as to be considered as a dangerous behavior, but could have led to the dangerous behavior) is data acquired from an experienced doctor, the condition judgment unit 15 extracts the moving average of the scores 5d respectively calculated for the above-mentioned plurality of pieces of data 1a as a specified pattern.

Then, the condition judgment unit 15 calculates the correlation between the above-mentioned specified pattern and the moving average of the above-mentioned scores 5e. In other words, the condition judgment unit 15 calculates the degree of coincidence (correlation) between them along the elapsed time and/or while shifting from one score to another. When the relevant correlation becomes higher, the condition judgment unit 15 judges that the latest score 5e will take a similar value in the future in conjunction with the aforementioned specified pattern (that is, there is a high possibility that a similar near-miss incident will occur).

Alternatively, the condition judgment unit 15 may judge whether the correlation between a transition of a third party's medical information (the data 1a) acquired by the unjudged data acquisition unit 11 in the past and a transition of the medical information (the data 1b) of a patient who is a dangerous behavior prediction object has become higher or not, as one of the above-mentioned specified conditions. For example, if the review result 5a indicating that the above-mentioned medical information (the data 1a) is about the situation where a near-miss incident has been experienced and that data is acquired from an experienced doctor, the condition judgment unit 15 calculates the correlation between these transitions of both pieces of the medical information; and when the relevant correlation becomes higher, the condition judgment unit 15 determines that the latest biological information will take a similar value in the future in conjunction with biological information in the past (that is, there is a high possibility that a similar near-miss incident will occur). The condition judgment unit 15 outputs the judgment result (judgment result 5f) to the relation evaluation unit 16.

When the unjudged medical information (the data 1b) regarding which whether it is related to a specified dangerous behavior or not is not judged is newly acquired, the relation evaluation unit 16 evaluates the relation between the relevant unjudged medical information and the specified dangerous behavior on the basis of the judged medical information (a pair of the data 1a and the review result 5a) regarding which whether it is related to the specified dangerous behavior or not is judged by a user (for example, a healthcare professional such as a doctor or a nurse). For example, when the score 5e calculated by the score calculation unit 14 as an index indicative of the relation between the unjudged medical information (the data 1b) and the specified dangerous behavior exceeds the threshold value 6 (that is, when it is determined by the condition judgment unit 15 that the score 5e exceeds the threshold value 6), the relation evaluation unit 16 evaluates that the relevant unjudged medical information is related to the specified dangerous behavior. The relation evaluation unit 16 outputs the evaluation result (evaluation result 5g) to the relation assignment unit 17.

The relation assignment unit 17 assigns relation information 5h indicating that the unjudged information (the data 1b) is related to the specified dangerous behavior, on the basis of the result evaluated by the relation evaluation unit 16 (the evaluation result 5g) and outputs the relevant relation information 5h to the prediction unit 18.

The prediction unit 18 predicts the patient's corresponding dangerous behavior from the unjudged medical information (the data 1b) according to the relation evaluated by the relation evaluation unit 16. Specifically speaking, the data reporting unit 21 predicts the above-mentioned patient's dangerous behavior on the basis of the data 1b to which the relation information 5h indicating that it is related to the specified dangerous behavior is assigned by the relation assignment unit 17. The prediction unit 18 outputs a prediction result 5i to the data reporting unit 21. The data reporting unit 21 outputs the prediction result of the prediction unit 18 to the prediction report demander.

The threshold value identification unit 19 identifies a minimum score that can exceeds a target value (target precision) set to precision indicative of a ratio of the data 1a judged to be related to the specified dangerous behavior to a data group including a specified number of pieces of data, as the threshold value of precision 6. Specifically speaking, when scores 5d are input from the score calculation unit 14, the threshold value identification unit 19 arranges the relevant scores 5d in descending order. Next, the threshold value identification unit 19 scans the review result 5a assigned to the relevant data 1a in order from the data 1a having a maximum score 5d (the score ranked first) and sequentially calculates a ratio (precision) of the number of pieces of data to which the review result 5a indicating that the relevant data is “related to the specified dangerous behavior” is assigned, to the number of pieces of data regarding which scanning has been completed at that moment.

For example, when the number of pieces of data 1a to which the review result 5a is assigned is 100 and scanning of data with scores ranked first to 20th has been completed and if the number of pieces of data to which the review result 5a indicating that the relevant data is “related to the specified dangerous behavior” is assigned is 18, the threshold value identification unit 19 calculates the precision as 0.9 (18/20). As another example, when scanning of data with scores ranked first to 40th has been completed and if the number of pieces of data to which the review result 5a indicating that the relevant data is “related to the specified dangerous behavior” is assigned is 35, the threshold value identification unit 19 calculates the precision as 0.875 (35/40).

The threshold value identification unit 19 calculates all precisions regarding the data 1a and identifies the minimum score that can exceed the target precision. Specifically speaking, when the threshold value identification unit 19 scans the precisions calculated regarding the relevant data 1a in order from the data 1a having the minimum score 5d (the score ranked 100th) and the relevant precision exceeds the target precision, it outputs the score corresponding to the relevant precision as the minimum score capable of maintaining the above-mentioned target precision (the threshold value of precision 6) to the condition judgment unit 15 and the storage unit 20.

When the element information 5c is input from the element evaluation unit 13, the storage unit 20 associates data elements included in the relevant element information 5c with evaluation results of the data elements (weights) and stores them in the memory unit 30. Specifically, the memory unit 30 functions as a storage unit that stores the medical information related to the dangerous behavior from the judged medical record information that is the medical record information which is linked to the incident report about the patient's dangerous behavior and identifies the dangerous behavior. Accordingly, the behavior prediction apparatus 100 can extract the data related to the specified dangerous behavior by analyzing the current data on the basis of the result of analyzing past medical information described in the medical record information linked to the incident report (the weights as the result of evaluation of the data elements). Furthermore, when the threshold value of precision 6 is input from the threshold value identification unit 19, the storage unit 20 stores the relevant threshold value of precision 6 in the memory unit 30.

The input unit (specified input unit) 40 accepts inputs from a doctor. FIG. 3 illustrates the configuration in which the behavior prediction apparatus 100 includes the input unit 40 (the configuration in which, for example, a keyboard and a mouse are connected as the input unit 40); however, the relevant input unit 40 may be an external input device (such as a client terminal) connected to the relevant behavior prediction apparatus 100 so that they can communicate with each other.

The memory unit (specified memory unit) 30 is a storage device configured of, for example, arbitrary storage media such as hard drives, SSDs (silicon state drives), semiconductor memories, or DVDs (Digital Versatile Discs) and stores, for example, control programs capable of controlling the medical record information, the element information 5c, the threshold value of precision 6, and/or the behavior prediction apparatus 100. Incidentally, FIG. 3 illustrates the configuration in which the behavior prediction apparatus 100 has the memory unit 30 built-in; however, the relevant memory unit 30 may be an external storage device connected to the relevant behavior prediction apparatus 100 so that they can communicate with each other.

### Recalculation of Weight

After the data 1b which is judged by the behavior prediction apparatus 100 to be related to the specified dangerous behavior is reported by the data reporting unit 21 to the dangerous behavior prediction report demander, the judged data acquisition unit 12 can accept feedback from the doctor with respect to the above judgment. Specifically speaking, the doctor can input whether each result judged by the behavior prediction apparatus 100 is reasonable or not, as the above-mentioned feedback.

The element evaluation unit 13 can re-evaluate each data element on the basis of the above-mentioned feedback. Specifically speaking, the element evaluation unit 13 calculates the weight of each data element according to the following expression.

$${w}_{i , L} = \sqrt{{w}_{i , L}^{2} + {γ}_{L} {w}_{i , L}^{2} - ϑ} = \sqrt{{w}_{i , L}^{2} + {\sum }_{l = 1}^{L} ( {γ}_{l} {w}_{i , l}^{2} - ϑ )} \qquad Math . 3$$

In the above expression, wi, L represents the weight of an i-th data element after L-th learning; and γL means a learning parameter for L-th learning and θ means a threshold value of learning effects.

Specifically speaking, the element evaluation unit 13 can recalculate the weight on the basis of the feedback newly obtained with respect to the judgment by the behavior prediction apparatus 100. As a result, the behavior prediction apparatus 100 can obtain the weight, which matches the object data to be analyzed, and calculate the score accurately on the basis of the relevant weight, and thereby extract the data of the medical information related to the specified dangerous behavior with higher precision.

### Processing Executed by Behavior Prediction Apparatus 100

Processing executed by the behavior prediction apparatus 100 (a method for controlling the behavior prediction apparatus 100) includes: a relation evaluation step, which is executed when the unjudged medical information (the data 1b) regarding which whether it is related to a specified dangerous behavior or not has not been judged is newly obtained, of evaluating the relation between the relevant unjudged medical information and the specified dangerous behavior on the basis of the judged medical information regarding witch whether it is related to the specified dangerous behavior is judged by the doctor (a pair of the data 1a and the review result 5a); and a data reporting step of reporting the unjudged medical information to a disease prediction report demander in accordance with the relation evaluated in the relation evaluation step.

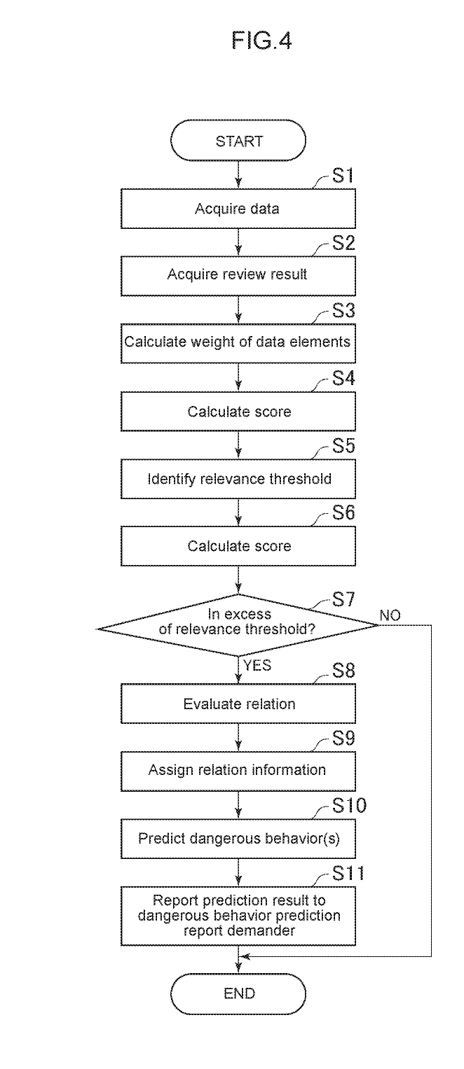

FIG. 4 is a detailed flowchart illustrating an example of the processing executed by the behavior prediction apparatus 100. It should be noted that any expression “XXX step” in parentheses in the following explanation represents each relevant step included in the above-mentioned behavior prediction apparatus controlling method.

The unjudged data acquisition unit 11 acquires the data 1a regarding which whether it is related to a specified dangerous behavior or not should be judged by the doctor (for example, from an electronic medical record) (step 1; “step” shall be hereinafter abbreviated as “S”). Next, the judged data acquisition unit 12 acquires the result judged by the doctor with respect to whether the data 1a is related to the specified dangerous behavior or not (the review result 5a), via the input unit 40 (S2). Subsequently, the element evaluation unit 13 evaluates each of data elements included in the data regarding with whether it is related to the specified dangerous behavior or not is judged by the doctor, on the basis of specified standards (S3). Then, the score calculation unit 14 calculates the score 5d indicative of the strength of the relation with the specified dangerous behavior, with respect to each piece of the data 1a on the basis of the result evaluated by the element evaluation unit 13 (the element information 5c) (S4). The threshold value identification unit 19 identifies the minimum score which can exceed the target value (target precision) set for the precision indicative of a ratio of the data 1a judged to be related to the specified dangerous behavior to the data group including a specified number of pieces of data, as the threshold value of precision 6 (S5).

Next, the score calculation unit 14 calculates the score 5e indicative of the strength of the relation with the specified dangerous behavior with respect to each piece of the data 1b on the basis of the result evaluated by the element evaluation unit 13 (the element information 5c) (S6). The condition judgment unit 15 judges whether or not the score 53 calculated with respect to the data 1b, regarding which whether it is related to the specified dangerous behavior has not been judged yet, exceeds the threshold value of precision 6, on the basis of the result evaluated by the element evaluation unit 13 (the element information 5c) (S7); and if it is determined that the score 53 exceeds the threshold value of precision 6 (YES in S7), the relation evaluation unit 16 evaluates that the data 1b is related to the specified dangerous behavior (S8: relation evaluation step).

The relation assignment unit 17 assigns the relation information indicating that the relevant data 1b is related to the specified dangerous behavior (the review result by the behavior prediction apparatus 10), to the data 1b evaluated by the relation evaluation unit 16 (S9). The prediction unit 18 predicts the patient's dangerous behavior corresponding to the unjudged medical record information according to the evaluation result in the relation evaluation step (S10: prediction step). Finally, the data reporting unit 21 reports the relevant data 1b to the dangerous behavior prediction report demander (S11: data reporting step).

It should be noted that the above-described control method may not only include the processing described above with reference to FIG. 4, but may also arbitrarily include processing executed by each unit included in the control unit 10.

### Advantageous Effects of Behavior Prediction Apparatus 100

When the unjudged medical information regarding which whether it is related to a specified dangerous behavior or not has not been judged is newly acquired, the behavior prediction apparatus 100 evaluates the relation between the relevant unjudged medical information and the specified dangerous behavior on the basis of the judged medical information, regarding which whether it is related to the specified dangerous behavior or not has been judged by the doctor, and reports the unjudged medical information to the disease prediction report demander according to the relevant relation as described above.

Therefore, the behavior prediction apparatus 100 has an advantageous effect of being capable of reporting a highly-reliable diagnosis result to the disease prediction report demander.

### Configuration Where Server Apparatus Provides Part or All of Functions

The above explanation has been given about the configuration (stand-alone configuration) where the behavior prediction apparatus controlling program capable of extracting the medical information related to the patient's specified dangerous behavior from a plurality of pieces of medical information acquired from the medical record information linked to the incident report is executed by the relevant behavior prediction apparatus 100.

On the other hand, another configuration may be possible where part or whole of the above-mentioned control program is executed at a server apparatus and the result of the executed processing is returned to the above-mentioned behavior prediction apparatus 100 (user terminal) (cloud configuration). Specifically speaking, the behavior prediction apparatus according to the present invention can function as the server apparatus connected to the user terminal via the network so that they can communicate with each other. As a result, when the above-mentioned behavior prediction apparatus 100 provides the functions, the server apparatus can have the same advantageous effects as those of the behavior prediction apparatus 100.

### Implementation Examples by Software

A control block (particularly the control unit 10) of the behavior prediction apparatus 100 may be implemented by a logical circuit (hardware) formed on, for example, an integrated circuit (IC chip) or may be implemented by software using a CPU (Central Processing Unit). In the latter case, the behavior prediction apparatus 100 includes, for example: a CPU for executing commands of a control program of the behavior prediction apparatus 100 which is software for implementing each function; a ROM (Read Only Memory) or a storage device (collectively referred to as the “storage media”) in which the above-mentioned control program and various kinds of data are recorded in a manner such that they can be read by the computer (or CPU); and a RAM (Random Access Memory) for expanding the above-mentioned control program. Then, the object of the present invention is achieved as the computer (or CPU) reads the above-mentioned control program from the above-mentioned storage media and executes it. As the above-mentioned storage media, “tangible media which are not temporary” such as tapes, disks, cards, semiconductor memories, or programmable logical circuits can be used. Furthermore, the above-mentioned control program may be supplied to the above-mentioned computer via an arbitrary transmission medium capable of transmitting the relevant control program (such as a communication network or a broadcast wave). The present invention can also be implemented in a form of a data signal embedded in a carrier wave in which the above-mentioned control program is embodied via electronic transmission.

Specifically speaking, the behavior prediction apparatus controlling program according to an embodiment of the present invention is a control program for having a computer implement a behavior prediction function predicting the patient's dangerous behavior and has the above-mentioned behavior prediction apparatus, which is implemented as the computer, implement a relation evaluation function and a data reporting function. The above-mentioned relation evaluation function and data reporting function can be implemented by the relation evaluation unit 16 and the data reporting unit 21 described earlier, respectively. The details are as described earlier.

It should be noted that the above-described control program can be implemented by using, for example, a script language such as Ruby, Perl, Python, ActionScript, or JavaScript (registered trademarks), an object-oriented programming language such as C++, Objective-C, or Java (registered trademarks), and a markup language such as HTML5.

### Supplement 1

The present invention is not limited to each of the aforementioned embodiments and various changes can be made within the scope indicated in claims and embodiments which can be obtained by combining technical means respectively disclosed in different embodiments as appropriate are also included in the technical scope of the present invention. Furthermore, a new technical feature can be formed by combining the technical means disclosed in each embodiment.

Furthermore, regarding the behavior prediction apparatus according to an embodiment of the present invention, the element evaluation unit can evaluate data elements by using a transmitted information amount indicative of the dependency relation between the data elements and a doctor's judgment result with respect to judged data including the data elements as one of specified standards.

### Supplement 2

A behavior prediction apparatus according to an embodiment of the present invention: acquires digital information including data, patient information, and access history information; identifies a specific patient from the patient information; extracts only data, which has been accessed by the specific patient, on the basis of the access history information about the designated specific patient; sets accessory information indicating whether a specified file included in the extracted data is related to a specified dangerous behavior or not; and outputs the specified file related to the specified dangerous behavior on the basis of the accessory information.

A behavior prediction apparatus according to an embodiment of the present invention: acquires digital information including data and patient information; sets patient identifying information indicating which one of patients included in the patient information is related to the relevant information; designates the patient; searches for a specified file to which the patient identifying information corresponding to the designated patient is set; sets accessory information indicating whether the searched specified file is related to a specified dangerous behavior or not; and outputs the specified file related to the specified dangerous behavior on the basis of the accessory information.

A behavior prediction apparatus according to an embodiment of the present invention: stores, in a data element database, (1a) categorization sign A, (1b) data elements included in data to which categorization sign A is assigned, and (1c) data element correspondence information indicative of a correspondence relation between categorization sign A and the data elements; stores, in a related data element database, (2a) categorization sign B, (2b) related data elements which appear in data with categorization sign B assigned thereto at high appearance frequency, and (2c) related data element correspondence information indicative of a correspondence relation between categorization sign B and the related data elements; assigns categorization sign A to the data including the data elements (1b) above on the basis of the data element correspondence information (1c) above; extracts the data including the related data elements (2b) above from the data to which categorization sign A is not assigned; calculates scores based on evaluation values and the number of the related data elements; assigns categorization sign B to data, whose score exceeds a certain value, on the basis of the above-calculated scores and the related data element correspondence information (2c) above; and accepts assignment of categorization sign C to data, to which categorization sign B is not assigned, from a doctor.

A behavior prediction apparatus according to an embodiment of the present invention: accepts input of categorization signs, which indicate the relation with a specified dangerous behavior, from the doctor in order to assign the categorization signs to data; categorizes the data by each categorization sign; analyzes and selects data elements which appear commonly in the categorized data; searches the data for the selected data elements; calculates scores indicative of the relation between the categorization signs and the data by using the searched result and the analysis result of the data elements; and assigns the categorization signs to the data on the basis of the calculated scores.

A behavior prediction apparatus according to an embodiment of the present invention: registers data elements for the doctor to judge whether the relevant data is related to a specified dangerous behavior or not, in a database; searches the database for the registered data elements; extracts sentences including the searched data elements from data; calculates a score indicative of the degree of association with the specified dangerous behavior according to a feature quantity extracted from the extracted sentences; and changes the degree of emphasis of the sentences according to the score.

A behavior prediction apparatus according to an embodiment of the present invention: records a result of relation judgment by the doctor on the relation with a specified dangerous behavior with respect to medical information or a progress speed of the relation judgment as actual performance information; generates prediction information about the result or the progress speed; compares the actual performance information with the prediction information; and generates an icon that presents evaluation of the doctor's relation judgment on the basis of the comparison result.

A behavior prediction apparatus according to an embodiment of the present invention: accepts input of result information indicative of the relation between data and a specified dangerous behavior from the doctor; calculates evaluation values of data elements, which appear commonly in the data, according to features of the data elements with respect to each piece of the result information; selects the data elements based on the evaluation values; calculate a score of the data on the basis of the selected data elements and their evaluation values; and calculates a recall ratio based on the score.

A behavior prediction apparatus according to an embodiment of the present invention: displays data to the doctor; accepts identification information (tag) assigned by the doctor to object data to be reviewed on the basis of judgment as to whether the relevant data is related to a specified dangerous behavior or not; compares a feature quantity of the object data, regarding which the tag has been accepted, with a feature quantity of the data; updates a score of the data corresponding to a specified tag; and controls a display order of data to be displayed on the basis of the updated score.

When a source code is updated, a behavior prediction apparatus according to an embodiment of the present invention: records the updated source code; creates an executable file from the recorded source code; executes the executable file for verification; and transmits the executed verification result; and a server accepts the distributed verification result.

A behavior prediction apparatus according to an embodiment of the present invention: displays data, regarding which the doctor judges the relation between the data and a specified dangerous behavior, and a classification button for the doctor to select a classification condition for classifying the data; accepts information about the classification button selected by the doctor as selection information; classifies the data according to an analysis result of the data on the basis of the selection information; and displays the data on the basis of the classification result.

A behavior prediction apparatus according to an embodiment of the present invention: checks each piece of accessory information of voice and image data; classifies the voice and image data on the basis of the accessory information; extracts elements included in the accessory information of the classified voice and image data; analyzes the degree of similarity on the basis of the extracted elements; and integrates and analyzes them on the basis of the degree of similarity.

A behavior prediction apparatus according to an embodiment of the present invention: extracts a file with a password, which is protected with the password; inputs candidate words, which are candidates for the password, to the file with the password by using a dictionary file in which the candidate words are registered; and accepts the result of judgment given by the doctor on the file, whose password has been canceled, with respect to the relation with a specified dangerous behavior.

A behavior prediction apparatus according to an embodiment of the present invention: divides data of a search object file in a binary format into a plurality of blocks; searches the search object file in the binary format for block data; and outputs the search result.

A behavior prediction apparatus according to an embodiment of the present invention: selects object digital information which is to be an investigation object; stores a plurality of combinations of words having the relation with a specified matter; and searches the selected object digital information to see whether it contains the plurality of stored combinations of words or not; and if the selected object digital information contains the plurality of stored combinations of words, the behavior prediction apparatus judges the relation between the object digital information and the specified matter on the basis of the result of morpheme analysis and associates the judgment result with the object digital information.

A behavior prediction apparatus according to an embodiment of the present invention: extracts an image group and a voice group from image information and voice information; accepts input of categorization signs from the doctor in order to assign the categorization signs to the image group and the voice group; categorizes the image group and the voice group by each categorization sign; analyzes and selects data elements which appear commonly in the categorized image group and voice group; searches the image information and the voice information for the selected data elements; calculates a score by using the search result and the result of analyzing the data elements; assigns the categorization signs to the image information and the voice information on the basis of the calculated score; displays the score calculation result and the categorization result on a screen; and calculates the number of necessary images and voices for recheck on the basis of the relation between a recall ratio and a normalized rank.

A behavior prediction apparatus according to an embodiment of the present invention: stores, in a data element database, (1a) categorization sign A, (1b) data elements included in data to which categorization sign A is assigned, and (1c) data element correspondence information indicative of a correspondence relation between categorization sign A and the data elements; stores, in a related data element database, (2a) categorization sign B, (2b) related data elements which appear in data with categorization sign B assigned thereto at high appearance frequency, and (2c) related data element correspondence information indicative of a correspondence relation between categorization sign B and the related data elements; assigns categorization sign A to the data including the data elements (1b) above on the basis of the data element correspondence information (1c) above; extracts the data including the related data elements (2b) above from the data to which categorization sign A is not assigned; calculates scores based on evaluation values and the number of the related data elements; assigns categorization sign B to data, whose score exceeds a certain value, on the basis of the above-calculated scores and the related data element correspondence information (2c) above; accepts assignment of categorization sign C to data, to which categorization sign B is not assigned, from the doctor; analyzes the data to which categorization sign C is assigned; and assigns categorization sign D to data, to which any categorization sign is not assigned, on the basis of the analysis result.

A behavior prediction apparatus according to an embodiment of the present invention calculates a score indicating the relation with a specified dangerous behavior with respect to each piece of data. The behavior prediction apparatus extracts data in a specified order on the basis of the calculated score; accepts categorization signs assigned by the doctor to the extracted data on the basis of the relation with the specified dangerous behavior; categorizes the extracted data by each categorization sign on the basis of the categorization signs; analyzes and selects data elements which appear commonly in the categorized data; searches the data for the selected data elements; and recalculates the score for each piece of data by using the search result and the analysis result.

A behavior prediction apparatus according to an embodiment of the present invention: stores information about a specified dangerous behavior in an investigation basic database (not shown in the drawings); accepts input of a category of the specified dangerous behavior; judges an investigation category which is an investigation object, on the basis of the accepted category; and extracts the type of necessary information from the investigation basic database.

A behavior prediction apparatus according to an embodiment of the present invention: stores a behavior occurrence model prepared based on a reception/transmission history of message files of an acting subject, who performed a specific behavior, over a network; prepares profile information of the subject on the basis of the subject's reception/transmission history of message files over the network; calculates a score indicative of precision between the profile information and the behavior occurrence model; and judges the possibility of occurrence of a specified behavior on the basis of the score.

A behavior prediction apparatus according to an embodiment of the present invention: collects a case investigation result including a categorization work result of each case with respect to a specified dangerous behavior; registers an investigation model parameter for investigating the specified dangerous behavior; searches for the registered investigation model parameter upon input of the investigation content of a new investigation case; extracts an investigation model parameter related to input information; outputs an investigation model by using the extracted investigation model parameter; and constitutes previous information to conduct investigation into a new investigation case on the basis of the output result of the investigation model.

A behavior prediction apparatus according to an embodiment of the present invention: acquires patient information about a patient; acquires updated digital information at regular time intervals on the basis of the patient information; organizes a plurality of files constituting the acquired digital information into a specified storage site on the basis of recording destination information, file names, and metadata with respect to the acquired digital information; and prepares a visualized status distribution indicating the status of the plurality of organized files so that the status of the patient who accessed the digital information can be recognized.

A behavior prediction apparatus according to an embodiment of the present invention: acquires metadata associated with digital information; updates a set of weighted parameters on the basis of the relation between first digital information, which has the relation with a specified matter, and the metadata; and updates the relation between morphemes and the digital information by using the set of weighted parameters.

A behavior prediction apparatus according to an embodiment of the present invention: accepts categorization signs manually assigned to object data; calculates a relation score of object data; judges whether the categorization signs are true or false, on the basis of the relation score; and determines a categorization sign to be assigned to the object data on the basis of the result of the true-or-false judgment.

A behavior prediction apparatus according to an embodiment of the present invention: accepts input of a category to which a specified dangerous behavior belongs; conducts investigation on the basis of the accepted category; prepare a report to report the investigation result; stores information related to the specified dangerous behavior in an investigation basic database; judges an investigation category which is an investigation object, on the basis of the accepted category; extracts necessary information types from the investigation basic database; presents the extracted necessary information types to the doctor; accepts input of data elements to be used to assign categorization signs corresponding to the presented information types from the doctor; and automatically assigns the categorization signs to the data.

A behavior prediction apparatus according to an embodiment of the present invention: acquires public information of a subject; analyzes the public information; outputs external elements of the subject; stores a behavior occurrence model based on external behavior elements of an acting subject who performed a specific behavior; extracts behavior factors, which match the behavior occurrence model, from the external elements of the subject and stores them; acquires internal information of the subject; analyzes the internal information; outputs internal elements of the subject; and automatically identifies an analysis object on the basis of similarity between the internal elements and the behavior factors.

A behavior prediction apparatus according to an embodiment of the present invention: acquires relation information indicative of the relation between digital information and a specified matter; calculates a relation score determined according to the relation between the digital information and the specified matter with respect to each piece of the digital information; calculates a ratio of the number of pieces of relation information assigned to the digital information included in the relevant range to a total number of pieces of digital information having the relation score included in each range with respect to each specified range of the relation score; and displays a plurality of sections associated with the respective ranges by changing hue, brightness, or color intensity on the basis of the ratio.

A behavior prediction apparatus according to an embodiment of the present invention: calculates scores indicative of the strength of linkage between data and categorization signs in a time-series manner; detects time-series changes of the scores from the calculated scores; and, upon judging the detected time-series changes of the scores, investigates and judges relevance between an investigation case and extracted data on the basis of the result of judging time when a score in excess of a specified reference value changed.

A behavior prediction apparatus according to an embodiment of the present invention: stores weighted information which is related to a specified matter and associated with a plurality of data elements including co-occurrence expressions; associates scores with digital information; extracts sample digital information, which is to be a sample, from the digital information on the basis of the scores; and updates the weighted information by analyzing the extracted sample digital information.

A behavior prediction apparatus according to an embodiment of the present invention: selects categories which are indexes capable of classifying each piece of data included in a plurality of pieces of data; and calculates a score for each category.

A behavior prediction apparatus according to an embodiment of the present invention: identifies a phase for classifying a specified act by a specified acting subject, which may cause a specified dangerous behavior, according to the progress of the specified act on the basis of a score; and estimates changes of the identified phase on the basis of time transient of the phase.

A behavior prediction apparatus according to an embodiment of the present invention: stores an occurrence process model regarding the occurrence of a specified act, which may cause a specified dangerous behavior, for each phase for classification according to the progress of the specified act; stores information related to the specified dangerous behavior for each category and each occurrence process model; stores time-series information indicative of a temporal order of the phase; analyzes image information and voice information on the basis of the above-mentioned information; and calculates an index indicative of the possibility of occurrence of the specified act from the analysis result.

A behavior prediction apparatus according to an embodiment of the present invention: stores generation process models for generating specified medical information, which may cause a specified dangerous behavior, by each phase for classification according to the specified progress; stores information related to the specified dangerous behavior with respect to each category and each generation process model; stores time-series information indicative of temporal order of the phases; stores the relation between a plurality of persons related to the specified dangerous behavior; analyzes data based on these pieces of information; and identifies the present phase.

When verbs representing operations are included in voices, a behavior prediction apparatus according to an embodiment of the present invention: identifies objects which represents objects of the operations; associates metadata indicative of attributes of the voices including the verbs and the objects; evaluates the relation between the voices and symptoms on the basis of the association; and displays the relation between a plurality of person related to the symptoms.

A behavior prediction apparatus according to an embodiment of the present invention: acquires communication data transmitted between a plurality of terminals and associated with each of a plurality of persons; analyzes the content of the acquired communication data; evaluates the relation between the content of the communication data and a specified dangerous behavior by using the analysis result; and displays the relation between a plurality of persons related to the specified dangerous behavior on the basis of the evaluation result.

A behavior prediction apparatus according to an embodiment of the present invention: calculates a score indicative of the strength of linkage between data included in a data group and categorization signs indicative of relevance between the data group and a specified dangerous behavior; reports the score to the doctor according to the calculated score; and outputs an investigation report depending on an investigation type of the specified dangerous behavior.

A behavior prediction apparatus according to an embodiment of the present invention: generates a data element vector indicating whether a specified data element is included in sentences contained in data (for example, voices at medical interviews) or not, with respect to each sentence; obtains a correlation vector with respect to each sentence by multiplying the data element vector by the correlation matrix indicative of a correlation between the specified data element and other data elements; and calculates a score on the basis of a totalized value of all correlation vectors.

A behavior prediction apparatus according to an embodiment of the present invention: learns weighting of data elements included in categorized data, regarding which whether it is related to a specified dangerous behavior or not is categorized by the doctor; searches uncategorized data, regarding which whether it is related to the specified dangerous behavior or not has not been categorized by the doctor, for data elements included in the categorized data; calculates a score that evaluates the strength of linkage between the uncategorized data and categorization signs by using weighting of the searched data elements and the learned data elements.

A behavior prediction apparatus according to an embodiment of the present invention can also analyze a patient's emotions included in medical record information and predict dangerous behaviors on the basis of the relevant emotions. In this case, the behavior prediction apparatus according to an embodiment of the present invention associates data elements included in the medical record information (data elements including the patient's emotional expressions, for examples, morphemes such as “feel better,” “hurt,” and “feel pain”) and stores them. For example, the behavior prediction apparatus searches texts included in medical record information to check whether predetermined keywords (the relevant keywords are words relating to emotions in a case of the texts) are included in the relevant texts or not. If they are included in the texts, the behavior prediction apparatus associates the relevant keywords with emotion scores calculated according to specified standards and stores them in a memory unit. The behavior prediction apparatus according to an embodiment of the present invention extracts keywords relating to predetermined emotions from unjudged medical record information. Then, the behavior prediction apparatus refers to the emotion scores associated with the extracted keywords in the memory unit. The behavior prediction apparatus according to an embodiment of the present invention integrates the emotion scores of the respective keywords extracted from the unjudged medical record information to obtain an emotion score of the relevant unjudged medical record information. For example, let us assume that a sentence reciting “my feet hurt recently and I feel unsteady when I stand up” is included in a text. Then, “hurt” and “feel unsteady” are stored in the memory unit in advance and are associated with the emotion scores “+1.4” and “+0.9” respectively. In this case, the behavior prediction apparatus according to an embodiment of the present invention obtains an emotion score “+2.3” by calculation as the emotion score of the relevant text by, for example, adding both the above-mentioned emotion scores. Then, the behavior prediction apparatus according to an embodiment of the present invention predicts a dangerous behavior (tumbling in this case) on the basis of the relevant emotion score.

Accordingly, the behavior prediction apparatus according to the present invention can: recognize a data group including a plurality of pieces of data (such as medical record information) as an “aggregate of data as a result of human thoughts and behaviors”; extract patterns from the data by conducting, for example, analysis related to the human behaviors, analysis to predict the human behaviors, analysis to detect specified human behaviors, and analysis to suppress the specified human behaviors; and evaluate the relation between the relevant patterns and a specified case (that is, a dangerous behavior). Therefore, the present invention can provide the technique to predict the occurrence of the patient's dangerous behavior.

### REFERENCE SIGNS LIST

1 Data; 1a data; 1b data; 5a review result (the result judged by a doctor); 5d score; 5e score; 6 threshold value of precision (a specified threshold value); 11 unjudged data acquisition unit; 12 judged data acquisition unit; 13 element evaluation unit; 14 score calculation section; 15 condition judgment unit (excess judgment unit); 16 relation evaluation unit; 17 relation assignment unit; 18 prediction unit; 19 threshold value identification unit; 20 storage unit; 21 data reporting unit; and 100 behavior prediction apparatus.

### INDUSTRIAL APPLICABILITY

The present invention can be used for the technique that predicts the occurrence of the patient's dangerous behavior.

1-21. (canceled)

22. A prediction apparatus for causing a computer o predict a dangerous state which may occur to a patient,
wherein the computer:
acquires an electronic medical record of the patient corresponding to a report, in which the dangerous state based on the patient's behavior is recorded, from a memory on the basis of the report;
acquires medical information from the acquired electronic medical record;
has a healthcare professional review the acquired medical information and set classification, which is indicative of a degree of association between the medical information and the dangerous state, to the acquired electronic medical record;
extracts a data element from the medical information and evaluates a degree of relation which the data element may have with respect to the classification;
acquires a processing-required electronic medical record, to which the prediction should be applied, from the memory;
evaluates the acquired processing-required electronic medical record on the basis of the data element and the evaluation given to the data element; and
predicts the dangerous state which may occur to the patient corresponding to the processing-required electronic medical record on the basis of a result of the evaluation of the processing-required electronic medical record.

23. The prediction apparatus according to claim 22,
wherein the computer:
evaluates the degree of the relation of the data element as a score;
calculates a score of the processing-required electronic medical record on the basis of the score of the data element; and
predicts the dangerous state which may occur to the patient corresponding to the processing-required electronic medical record on the basis of the score of the processing-required electronic medical record and reports a result of the prediction to the healthcare professional.

24. The prediction apparatus according to claim 23,
wherein the computer:
calculates scores of a plurality of electronic medical records, which have been acquired, on the basis of the score of the data element;
sets a target value as a precision ratio which is a ratio of electronic medical records classified as being related to the dangerous state to the plurality of acquired electronic medical records among the calculated scores;
sets a score in excess of the target value as a threshold value; and
determines that the dangerous state may occur to the patient corresponding to the processing-required electronic medical record with the score in excess of the threshold value.

25. The prediction apparatus according to claim 23,
wherein the computer:
calculates scores of a plurality of electronic medical records, which have been acquired, on the basis of the score of the data element; and
evaluates whether a correlation between a moving average of the scores calculated respectively for the plurality of electronic medical records acquired in chronological order and a moving average of scores calculated respectively for a plurality of processing-required electronic medical records acquired in chronological order is high or low; and
evaluates a relation between medical information included in the processing-required electronic medical records and the dangerous state on the basis of a result of the judgment.

26. The prediction apparatus according to claims 22,
wherein the computer assigns relation information, which indicates that the medical information included in the processing-required electronic medical record is related to the dangerous state, to the relevant processing-required electronic medical record on the basis of a result of the evaluation of the processing-required electronic medical record.

27. The prediction apparatus according to claims 22,
wherein the computer:
sets tumbling and/or falling recorded in the report as the dangerous state; and
predicts whether the dangerous state may occur to the patient corresponding to the processing-required electronic medical record, according to a result of the evaluation of the processing-required electronic medical record.

28. A prediction method for causing a computer to predict a dangerous state which may occur to a patient,
the prediction method comprising the following steps executed by the computer:
a step of acquiring an electronic medical record of the patient corresponding to a report, in which the dangerous state based on the patient's behavior is recorded, from a memory on the basis of the report;
a step of acquiring medical information from the acquired electronic medical record;
a step of having a healthcare professional review the acquired medical information and set classification, which is indicative of a degree of association between the medical information and the dangerous state, to the acquired electronic medical record;
a step of extracting a data element from the medical information and evaluating a degree of relation which the data element may have with respect to the classification, and acquiring a processing-required electronic medical record, to which the prediction should be applied, from the memory;
a step of evaluating the acquired processing-required electronic medical record on the basis of the data element and the evaluation given to the data element; and
a step of predicting the dangerous state which may occur to the patient corresponding to the processing-required electronic medical record on the basis of a result of the evaluation of the processing-required electronic medical record.

29. A non-transitory computer readable storage medium which stores a program for causing a computer to predict a dangerous state which may occur to a patient,
wherein the program causes the computer to implement:
a function that acquires an electronic medical record of the patient corresponding to a report, in which the dangerous state based on the patient's behavior is recorded, from a memory on the basis of the report;
a function that acquires medical information from the acquired electronic medical record;
a function that has a healthcare professional review the acquired medical information and set classification, which is indicative of a degree of association between the medical information and the dangerous state, to the acquired electronic medical record;
a function that extracts a data element from the medical information and evaluates a degree of relation which the data element may have with respect to the classification and acquires a processing-required electronic medical record, to which the prediction should be applied, from the memory;
a function that evaluates the acquired processing-required electronic medical record on the basis of the data element and the evaluation given to the data element; and
a function that predicts the dangerous state which may occur to the patient corresponding to the processing-required electronic medical record on the basis of a result of the evaluation of the processing-required electronic medical record.
